(19) United States
(12) Patent Application Publication
(10) Pub. No.: US 2012/0111197 A1
(43) Pub. Date: May 10, 2012

(54) FILTER RACK, FILTER ASSEMBLY, AND METHOD OF FILTERING AIR

(75) Inventor: Gary WEISMAN, Sarasota, FL (US)

(73) Assignee: ENERGY MANAGEMENT PRODUCTS, LLC, Sarasota, FL (US)

(21) Appl. No.: 12/943,723

(22) Filed: Nov. 10, 2010

(51) Int. Cl. B01D 46/42; B01D 46/00

(52) U.S. Cl. 95/273; 55/481; 55/505

(57) ABSTRACT

A filter assembly includes a main body configured to attach to an air duct and having an opening defining an air flow area dimensioned to match dimensions of the air duct. A track is disposed outside of the air flow area; and a filter is disposed in the track. A method of filtering air with a filter including a filter medium and a filter frame surrounding the filter medium includes installing the filter along a duct which defines an air flow area so that the filter frame is disposed entirely outside of the air flow area; and moving air through the duct along the air flow area and through the filter medium.

### BACKGROUND OF THE INVENTION

1. Field of the Invention

The present invention relates to air conditioning and heating systems, and more specifically to a filter assembly.

2. Description of Related Art

Air conditioning and heating systems generally include ducts through which air flows, and a filter, such as a high-efficiency particulate air (HEPA) filter, disposed along the duct, to filter the air flowing therethrough. Typically, the filter includes a filter frame constructed around the complete perimeter of filter medium. The filter oftentimes is removably disposed in a filter rack.

However, when the filter is placed in the filter rack within the duct, the filter frame of the filter blocks some of the air flow and thereby effectively reduces the area through which air flows. Furthermore, many filters do not adequately provide a seal between the filter and the filter rack, thereby allowing air to flow around the sides of the filter, reducing the efficiency of filtration.

Accordingly, there remains a need for an air filter and filter assembly that allow air to flow therethrough effectively, permit easy removal and replacement of the filter, and properly seal the filter.

### SUMMARY OF THE INVENTION

According to one formulation, a filter assembly is provided which includes a main body configured to attach to an air duct and including an opening defining an air flow area dimensioned to match interior dimensions of the air duct; a track disposed outside of the air flow area; and a filter disposed in the track. The filter may be slidably disposed in the track. The main body and the track may be formed as a single integral piece.

The filter may include a filter medium and a filter frame disposed around a periphery of the filter medium, wherein the filter frame is disposed within the track and outside of the air flow area. The filter frame may be disposed entirely within the track. The filter frame may be disposed completely outside of the air flow area, and the filter medium may completely cover the air flow area. The filter frame may be recessed in the track, and in particular 100% of the filter frame may be recessed in the track. The filter may include a seal disposed along at least one of an entire periphery of the main body and an entire periphery of the filter.

The filter may include a door disposed along at least one side of the filter and wherein the door secures the filter within the main body in a closed position. The door may include a recess in which a portion of the filter is disposed when the door is in the closed position. The door may include a projection disposed along at least one edge of the door, and the main body may include a recess which receives the projection of the door to position the door with respect to the main body. The door may be substantially L-shaped. One of the main body and the door may include a clip, and the other of the main body and the door may include a clip-receiving portion which engages the clip to fasten the door in a closed position.

The main body and the door, together, may form a space which accommodates the filter. Specifically, the main body may include an open side configured to receive the filter when the filter is inserted in the track, the track may include an open portion, and the door may close the open portion when the door is in the closed position.

According to another formulation, a filter rack is provided which includes a main body configured to attach to an air duct and including an opening defining an air flow area dimensioned to match interior dimensions of the air duct, and a track disposed outside of the air flow area and configured to receive a filter frame.

The filter rack may include a seal which substantially seals the filter frame and the main body and which is disposed along an entire periphery of the main body. The main body may include an open side configured to receive the filter when the filter is inserted in the track.

According to another formulation, a filter system is provided which includes an air duct defining an air flow area; a main body attached to the air duct; a track disposed outside of the air flow area; and a filter disposed in the track.

The filter may include a filter medium and a filter frame disposed around a periphery of the filter medium, and filter frame may be disposed within the track and completely outside of the air flow area.

According to another formulation, a method of filtering air with a filter including a filter medium and a filter frame surrounding the filter medium is provided, wherein the method includes installing the filter along a duct which defines an air flow area so that the filter frame is disposed entirely outside of the air flow area, and moving air through the duct through the air flow area and through the filter.

The method may include sealing the filter and the duct at a downstream edge of the filter.

According to another formulation, a filter assembly includes a main body including an attachment portion configured to attach to an air duct; a track disposed outside of the attachment portion; and a filter disposed in the track.

According to yet another formulation, a filter assembly includes a filter rack configured to attach to an air duct and comprising a track, and a filter disposed in the track, wherein the track is integrally formed with a remainder of the filter rack as a single piece of material.

The exemplary embodiments of the invention provide a cost-effective, high-efficiency filter which reduces airflow interference and which is easily accessible.

### BRIEF DESCRIPTION OF THE FIGURES

The following drawings further describe by illustration advantages and aspects of the present invention:

FIG. 1A is a perspective view of an exemplary embodiment of a filter assembly illustrating the filter rack with the filter in phantom;

FIG. 1B is a perspective view of the exemplary embodiment of the filter assembly of FIG. 1A illustrating the filter rack and a filter partially inserted into the filter rack;

FIG. 2 is a side view of the filter assembly of FIG. 1;

FIG. 3 is a front view of a filter assembly of FIG. 1;

FIG. 4 is a front schematic view of an exemplary embodiment of an air handler including a filter assembly; and

FIG. 5 is a flow diagram of an exemplary embodiment of the method of filtering air using a filter assembly of the invention.

### DETAILED DESCRIPTION OF EXEMPLARY EMBODIMENTS OF THE INVENTION

Throughout the detailed description like reference numerals correspond to like elements, and repetitive description of such elements, albeit not included with express disclosure, nonetheless forms part of the application's inherent disclosure.

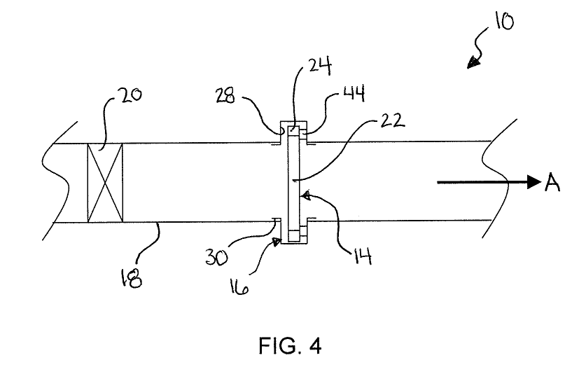

A filter system or air handler 10 includes a filter assembly 12 comprising a filter 14 mounted in a filter rack 16, or filter housing, along an air duct 18. The air handler 10 moves air along a path in the direction of arrow A through the duct 18 for the purpose of heating, ventilation, filtration, humidifying, de-humidifying, or otherwise conditioning of the air passing therethrough. As an example, the air handler 10 includes a blower 20, as shown in FIG. 4.

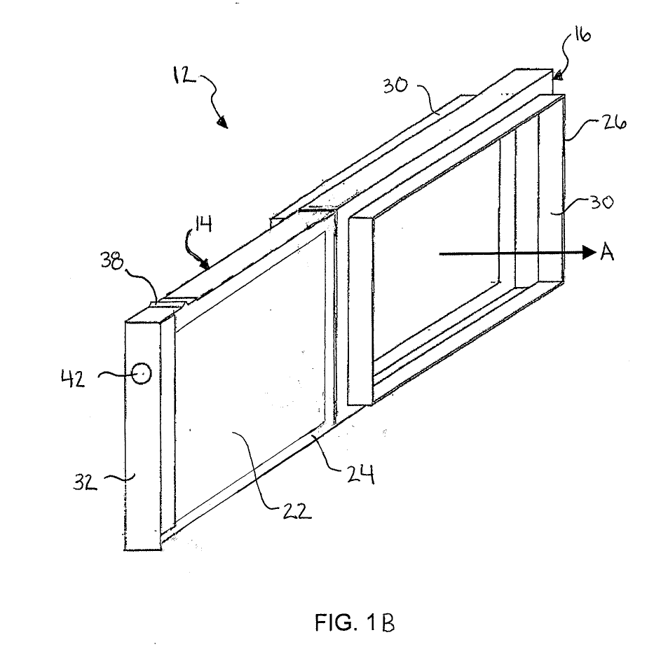

The filter 14 is a disposable filter comprising an air permeable filter medium 22 supported by a filter frame 24 disposed around an entire perimeter of the filter medium 22, as best shown in FIG. 2. The filter medium 22 may be, for example, a material which allows air to pass therethrough but prevents particles of a predetermined diameter and greater, or certain types of particles, from passing therethrough. The filter frame 24 includes a relatively rigid material for providing stability to the filter medium 22 so that the filter is self-supporting. The filter medium 22 is porous to air while the filter frame 24 is preferably impervious to air.

The filter rack 16 includes a main body 26 configured to attach to the air duct 18 and defining an opening through which air flows along the path A. For example, two sections of ducting may be fastened to respective ends of the filter rack 16. The opening defines an air flow area which is dimensioned to substantially match the interior dimensions of the air duct, such that the area through which air flows from one portion of the duct 18, through the filter 14 supported by the filter rack 16, and into another portion of the duct 18 remains the same size. For example, the shape and inner or outer dimensions of an end of the ducting may be configured to attach to the ends of the sections of ducting. The main body 26 may be metal or plastic, or some sturdy material other than metal or plastic.

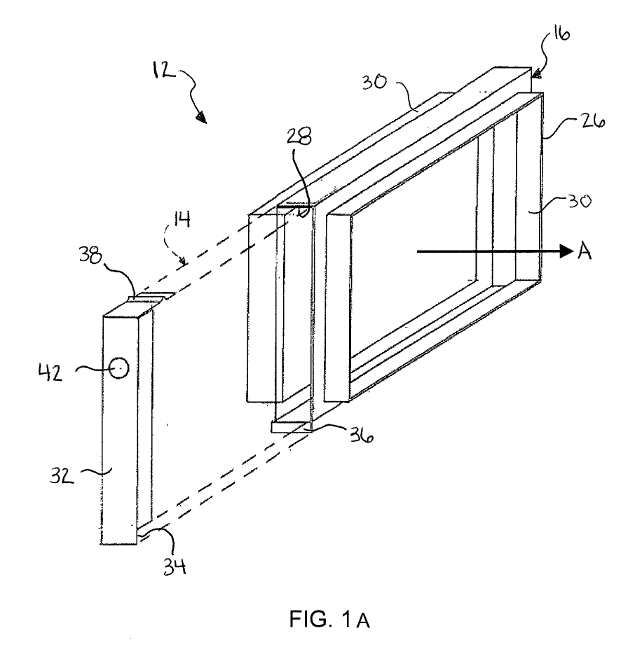

The filter rack 16 also includes a track 28 is disposed outside of the air flow area, i.e., outside of the boundaries which define the space through which the air flows, and receives the filter 14, as shown in FIGS. 1A and 1B. The main body 26 and the track 28 are preferably integrally formed as an integral body from a single piece of material, i.e., without including multiple pieces that are fastened to one another. This eliminates the need to seal the junction of the track 28 and the main body 26. The track 28 can accommodate various widths of filters 14, and thus the filter rack 16 may be used with any filter which is designed for the system.

Conventionally, a track is a separate piece which is disposed within the main body such that the track is required to be sealed with the main body which causes possible air leaks. In the exemplary embodiments, since the track 28 and the main body 26 are formed as a single integral piece, the possibility of air leakage between the track 28 and the main body 26 is eliminated.

The filter rack 16 includes the track 28 disposed along three sides thereof, wherein the fourth side of the filter rack 16 is open, i.e., both the main body 26 and the track 28 of the filter rack 16 include an open side. The open side is configured to receive the filter 14 when the filter 14 is inserted in the track 28. As such, as shown in FIGS. 1A and 1B, the filter 14 is positioned into the track 28 through the open fourth side of the main body 26 of the filter rack 16.

The filter 14 is inserted by being slid along the track 28 such that the filter frame 24 is disposed entirely within the track 28, i.e., the entire filter frame 24 is within the track 28, and outside of the path, as best shown in FIG. 4. The filter frame 24 is recessed within the track 28, and preferably 100% of the filter frame 24 is recessed within the track 28 such that the filter frame 24 is disposed completely outside of the air flow area and the filter medium completely covers the air flow area. That is, the innermost edge of the filter frame 24 is radially outside of the innermost edge of the track 28. The precise amount in which the filter frame 24 is recessed within the track is based on which filter is to be used in the filter system, which is determined based on, for example, the desired amount of efficiency and the requirements of the filter system.

The filter rack 16 includes an attachment portion configured to attach to the air duct 18. For example, the filter rack 16 includes filter flanges 30 extending at right angles relative to the track 28, as shown in FIGS. 1 and 4, to form an interface with the air duct 18. The filter flanges 30 are mechanically attached to the duct 18 through a fastener (not shown), such as clips or screws. The track 28 is disposed outside of the attachment portion, i.e., radially more distant from the air duct 18 (when viewed in cross-section) than the attachment portion.

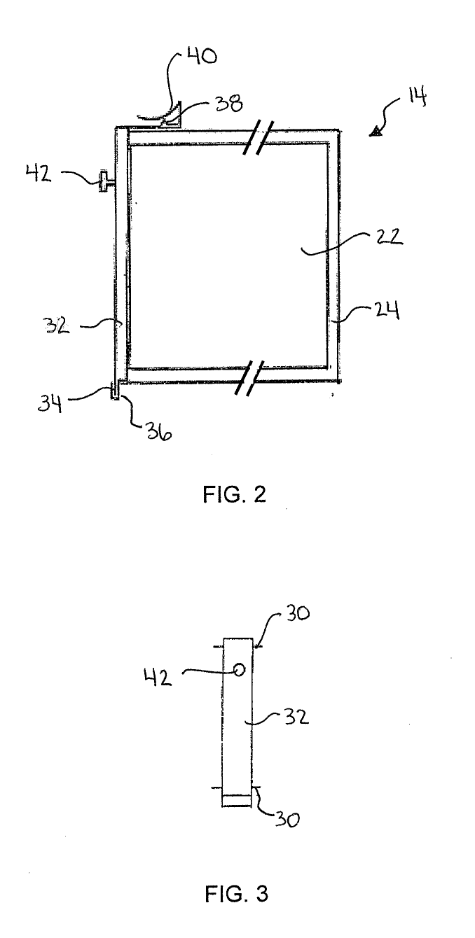

As illustrated in FIGS. 2 and 3, the filter 14 includes a door 32 disposed along at least one side thereof, which secures the filter 14 within the main body 26 of the filter rack 16 in a closed position and forms the fourth side of the main body 26. A bottom edge of the door 32 includes a projection, such as a bottom flange 34 extending downwardly from the door 32, which is received by a recess on the filter rack 16, such as a notch 36 at the bottom of the filter rack 16 to position the door 32 with respect to the main body 26. The door 32 has substantially an L-shape, as best shown in FIG. 2, including two plates that extend at a 90 degree angle relative to one another.

One of the main body 26 and the door 32 includes a clip 38, and the other of the main body 26 and the door 32 includes a clip-receiving portion 40, which engages the clip 38 to fasten the door 32 in a closed position. The clip-receiving portion 40 and the clip 38 allow the door to snap on and off to provide easy assembly and accessibility. For example, the clip 38 may be a projecting member and the clip-receiving portion 40 may be a resilient claw-like member which deforms to allow the clip 38 to be inserted thereinto and moves back into a non-deformed or semi-deformed state to retain the clip thereinside. The exemplary embodiment of FIGS. 1-3 includes the clip disposed on the door 32 and the clip-receiving portion 40 disposed along a top surface of the track 28. To attach the door 32, the bottom flange 34 is inserted into the notch 36 of the filter rack 16, and the clip 38 is secured to the clip-receiving portion 40. In the attached position, the door 32 includes a recess which accommodates a portion of the filter frame 24. The recess is disposed outside of the path of the air duct 18 such that the filter frame 24 alongside the door 32 does not extend into the path. That is, the recess and the track 28 are in continuity when the door 32 is in the closed position, to provide a space which accommodates the entire filter frame 24. A metal or plastic knob 42 is disposed on an outer surface of the door 32, to facilitate removal of the door 32 from the filter rack 16.

As shown in the exemplary embodiments, the main body 26 is rectangular and the track 28 extends parallel to and radially outwardly of outside surfaces of the main body 26 on three sides of the main body 26. The door 32 and/or the open side of the main body 26 form a fourth side of the track 28 such that the track 28 surrounds the main body 26. That is, the track 28 includes an open portion, and the door closes the open portion when the door is in the closed position.

As shown in FIG. 4, a seal 44, such as a rubber or plastic gasket, is attached to the entire periphery of the filter 14 and/or to an entire periphery of the main body 26 of the filter rack 16, to tightly and completely close the main body 26 and the filter 14 and thereby form an airtight seal between the filter 14 and the filter rack 16. The filter 14 includes dimensions, e.g., height, width, and depth, which are determined based on the height, width, and depth of the main body 26.

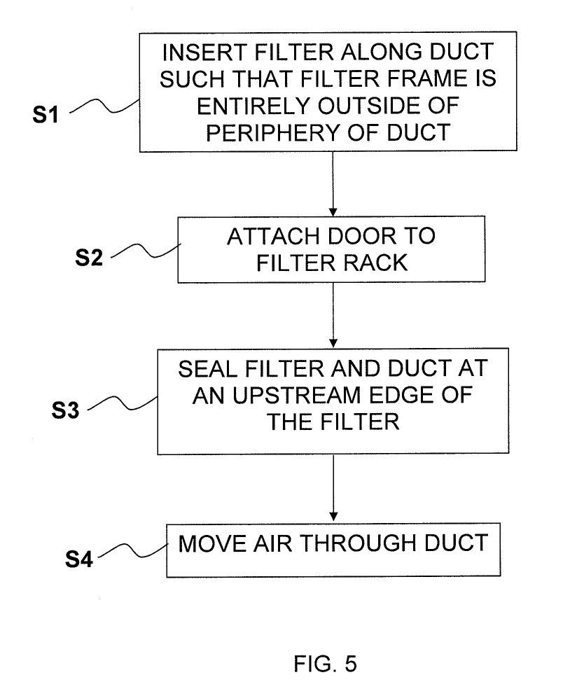

As shown in FIG. 5, a method of filtering air with the filter 14, which includes the filter medium 22 and the filter frame 24 surrounding the filter medium 22, includes installing the filter 14 along the duct 18 which defines the air flow path such that the filter frame 24 is disposed entirely outside of the path at step S1, closing the door 32 at step S2, and thereafter moving air through the duct 18 along the path and through the filter medium 22 at step S4. The method also includes sealing the filter 14 and the duct 18 at a downstream edge of the filter 14 at step S3. Preferably, the sealing is achieved by moving the air to create a lower pressure on a downstream side of the filter 14 than on an upstream side of the filter 14. The sealing causes the air flow to move substantially exclusively through the filter medium.

The exemplary embodiments dispense with electric connectors supplying an electric charge to electrostatic filters. However, electrostatic filters not requiring wiring may be used with the present exemplary embodiments.

The exemplary embodiments provide a filter assembly which has minimal obstruction, a tighter fit of the filter within the filter rack, may be pre-fabricated, is low-cost, and is easily accessible.

While the foregoing has described the general physical aspects of the invention and is to serve as an aide to better understanding the intended use and application of the invention, one skilled in the art will understand that the present invention is not limited to the detailed construction, fabrication, material or application of use described and illustrated herein. The applicant seeks, therefore, to cover all such changes and modifications as fall within the spirit and scope of the inventive concept, as defined in the appended claims, and equivalents thereof.

What is claimed is:

1. A filter assembly comprising;
a main body configured to attach to an air duct and comprising an opening defining an air flow area dimensioned to match interior dimensions of the air duct;
a track disposed outside of the air flow area; and
a filter disposed in the track.

2. The filter assembly according to claim 1, wherein the filter comprises a filter medium and a filter frame disposed around a periphery of the filter medium, and wherein the filter frame is disposed within the track and outside of the air flow area.

3. The filter assembly according to claim 2, wherein the filter frame is disposed completely outside of the air flow area, and the filter medium completely covers the air flow area.

4. The filter assembly according to claim 2, wherein the filter frame is recessed in the track.

5. The filter assembly according to claim 4, wherein 100% of the filter frame is recessed in the track.

6. The filter assembly according to claim 1, further comprising a seal disposed along at least one of an entire periphery of the main body, and an entire periphery of the filter.

7. The filter assembly according to claim 1, wherein the filter comprises a door disposed along at least one side of the filter and wherein the door secures the filter within the main body in a closed position of the door.

8. The filter assembly according to claim 7, wherein the door comprises a recess in which a portion of the filter is disposed when the door is in the closed position.

9. The filter assembly according to claim 7, wherein the door comprises a projection disposed along at least one edge of the door, and the main body comprises a recess which receives the projection of the door to position the door with respect to the main body.

10. The filter assembly according to claim 7, wherein one of the main body and the door comprises a clip and the other of the main body and the door comprises a clip-receiving portion which engages the clip, to fasten the door in the closed position.

11. The filter assembly according to claim 7, wherein the track comprises an open portion, and the door closes the open portion when the door is in the closed position.

12. The filter assembly according to claim 1, wherein the main body includes an open side configured to receive the filter when the filter is inserted in the track.

13. The filter assembly according to claim 7, wherein the door is substantially L-shaped.

14. The filter assembly according to claim 1, wherein the filter is slidably disposed in the track.

15. The filter assembly according to claim 1, wherein the main body and the track are formed as a single integral piece.

16. A filter rack comprising:
a main body configured to attach to an air duct and comprising an opening defining an air flow area dimensioned to match interior dimensions of the air duct;
a track disposed outside of the air flow area and configured to receive a filter frame.

17. The filter rack according to claim 16, further comprising a seal which substantially seals the filter frame and the main body and which is disposed along an entire periphery of the main body.

18. The filter rack according to claim 16, wherein the main body includes an open side configured to receive the filter when the filter is inserted in the track.

19. A filter system comprising:
an air duct defining an air flow area;
a main body attached to the air duct;
a track disposed outside of the air flow area; and
a filter disposed in the track.

20. The filter system according to claim 19, wherein the filter comprises a filter medium and a filter frame disposed around a periphery of the filter medium, and wherein the filter frame is disposed within the track and completely outside of the air flow area.

21. The filter system according to claim 19, wherein the main body and the track are provided as a single integral piece of material.

22. A method of filtering air with a filter comprising a filter medium and a filter frame surrounding the filter medium, the method comprising:
installing the filter along a duct which defines an air flow area so that the filter frame is disposed completely outside of the air flow area; and
moving air through the duct along the air flow area and through the filter medium.

23. The method according to claim 22, further comprising sealing the filter and the duct at a downstream edge of the filter.

24. The method according to claim 23, wherein the sealing is achieved by the moving of the air to establish a lower pressure on a downstream side of the filter than on an upstream side of the filter.

25. The method according to claim 22, wherein the sealing causes the air flow to move at least substantially exclusively through the filter medium.

26. A filter assembly comprising:
a main body comprising an attachment portion configured to attach to an air duct; and
a track disposed radially outside of the attachment portion.

27. A filter assembly comprising;
a filter rack configured to attach to an air duct and comprising a track; and
a filter disposed in the track,
wherein the track is integrally formed with a remainder of the filter rack as a single piece of material.
